(19) United States
(12) Patent Application Publication
(10) Pub. No.: US 2021/0117822 A1
(43) Pub. Date: Apr. 22, 2021

(54) SYSTEM AND METHOD FOR PERSISTENT STORAGE FAILURE PREDICTION

(71) Applicant: EMC IP Holding Company LLC, Hopkinton, MA (US)

(72) Inventors: Rahul Deo Vishwakarma, Bangalore (IN); Bing Liu, Tianjin (CN)

(21) Appl. No.: 16/656,875

(22) Filed: Oct. 18, 2019

(51) Int. Cl. G06N 5/04; G06N 20/00

(52) U.S. Cl. CPC G06N 5/04; G06N 20/00

(57) ABSTRACT

Systems, devices, and methods for reducing the impact of persistent storage failures. Specifically, a system may monitor persistent storages and generate predictions of when such storages are likely to fail. The generated predictions may be used to proactively address potential future failures of the persistent storages. A failure prediction system may generate predictions of future persistent storage failures in a manner that is computationally efficient. To generate the predictions, the system may utilize at least two prediction frameworks (e.g., trained machine learning models). The first of the prediction frameworks may generate accurate predictions at a higher computational cost than the second prediction framework. The second predictions framework may be a refined version of the first prediction framework that generates predictions in a computationally efficient manner. The second prediction framework may utilize smaller amounts of data for generating predictions than the first prediction framework.

### BACKGROUND

Devices may generate information based on existing information. For example, devices may obtain information and derive information based on the obtained information. To obtain information, devices may be able to communicate with other devices. The communications between the devices may be through any means.

### SUMMARY

In one aspect, a failure prediction system for predicting when persistent storage failures of clients will occur including persistent storage and a predictor. The persistent storage stores baseline training data and refinement training data. The predictor generates an initial prediction model using an initial machine learning algorithm and the baseline training data, generates a refined model using the refinement training data, a second machine learning algorithm, and the initial model, generates a prediction using the refined model and live data from a client of the clients, makes a determination that the prediction implicates an action, and initiates performance of the action based on the determination.

In one aspect, a method for operating a persistent storage failure prediction system including generating an initial prediction model using an initial machine learning algorithm and baseline training data, generating a refined model using refinement training data, a second machine learning algorithm, and the initial model, and generating a prediction using: the refined model, and live data from a client of the clients.

In one aspect, a non-transitory computer readable medium including computer readable program code, which when executed by a computer processor enables the computer processor to perform a method for operating a persistent storage failure prediction system. The method includes generating an initial prediction model using an initial machine learning algorithm and baseline training data, generating a refined model using: refinement training data, a second machine learning algorithm, and the initial model, generating a prediction using the refined model, and live data from a client of the clients, making a determination that the prediction implicates an action, and initiating performance of the action based on the determination.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in time in accordance with one or more embodiments of the invention.

FIG. 2 shows a diagram of a predictor in accordance with one or more embodiments of the invention.

FIG. 3 shows a diagram of a training data repository in accordance with one or more embodiments of the invention.

FIG. 4 shows a diagram of a training data set in accordance with one or more embodiments of the invention.

FIG. 5A shows a flowchart of a method of remediating a potential persistent storage failure in accordance with one or more embodiments of the invention.

FIG. 5B shows a flowchart of a method of generating a refined model in accordance with one or more embodiments of the invention.

FIG. 5C shows a flowchart of a method of refining a model in accordance with one or more embodiments of the invention.

FIG. 6A show a diagram of an example system.

FIGS. 6B-6D show diagrams of actions performed by the example system of FIG. 6A over time.

FIG. 7 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to systems, devices, and methods for reducing the impact of persistent storage failures. Specifically, a system in accordance with embodiments of the invention may monitor persistent storages and generate predictions of when such storages are likely to fail. The generated predictions may be used to proactively address potential future failures of the persistent storages. By doing so, the impact of persistent storage failures on systems may be reduced.

A system in accordance with embodiments of the invention may generate predictions of future persistent storage failures in a manner that is computationally efficient. To generate the predictions, the system may utilize at least two prediction frameworks (e.g., trained machine learning models). The first of the prediction frameworks may generate accurate predictions at a higher computational cost than the second prediction framework. The second predictions framework may be a refined version of the first prediction framework that generates predictions in a computationally efficient manner. The second prediction framework may utilize smaller amounts of data for generating predictions than the first prediction framework.

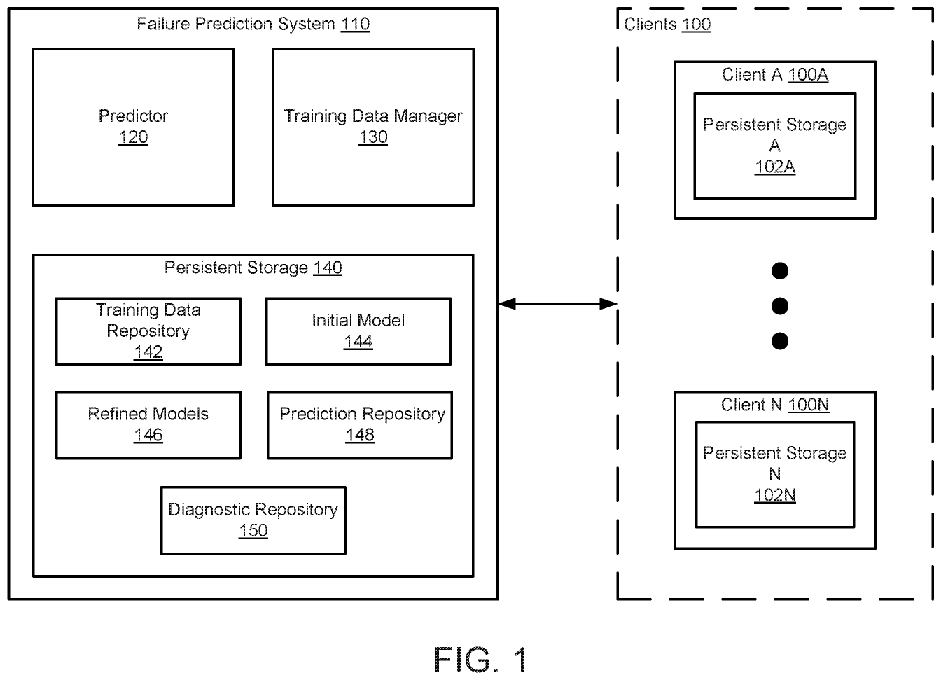

FIG. 1 shows an example system in accordance with one or more embodiments of the invention. The system may include clients (100) that obtain persistent storage failure prediction services from a failure prediction system (110). The persistent storage failure prediction services may include generating persistent storage failure predictions for the clients (100). The persistent storage failure prediction services may further include initiating actions for the clients (100) based on the predictions. By utilizing such services, data that may be relevant to the clients (100) may be stored in a persistent storage (140) of the failure prediction system (110).

Prior to generating predictions, the failure prediction system (110) may use a training data manager (130) to obtain training data associated with the clients (100), store the training data in the persistent storage (140) of the failure prediction system (110), and may enable the predictor (120) to access the training data. The predictor may use the training data to generate prediction models that may be stored in persistent storage (140). The generated predictions may indicate a likelihood of a persistent storage failure occurring.

To generate the predictions, the predictor (120) may utilize multiple types of prediction models. A first type of prediction model may be an initial model (144), which may be used to generate a refined model (146). The predictor (120) may then generate a refined model (146) using the initial model (144). The predictor may produce any number of prediction models.

The components of the system illustrated in FIG. 1 may be operably connected to each other and/or operably connected to other entities (not shown) via any combination of wired and/or wireless networks. Each component of the system illustrated in FIG. 1 is discussed below.

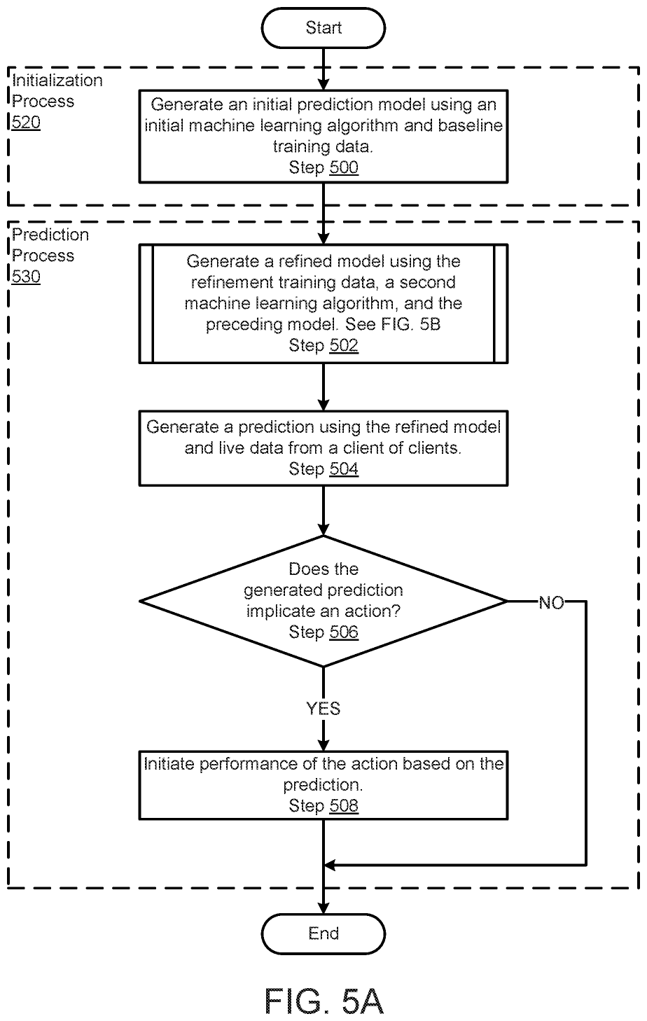

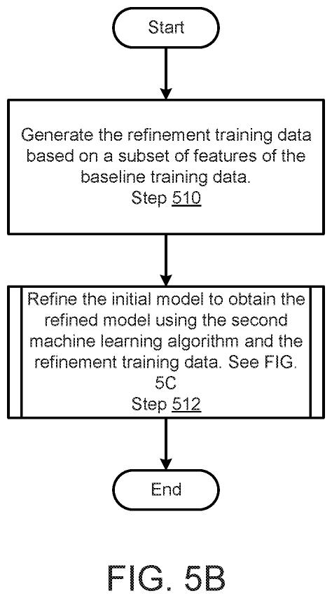

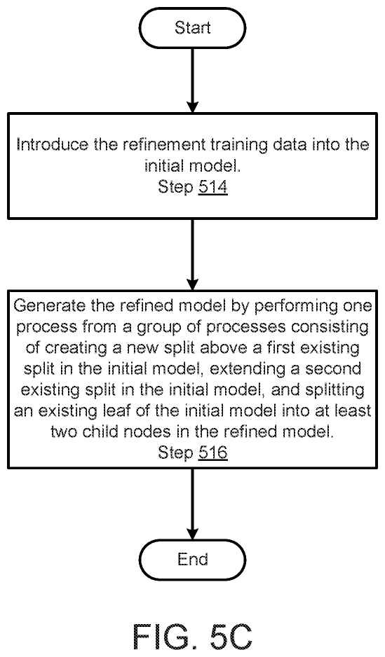

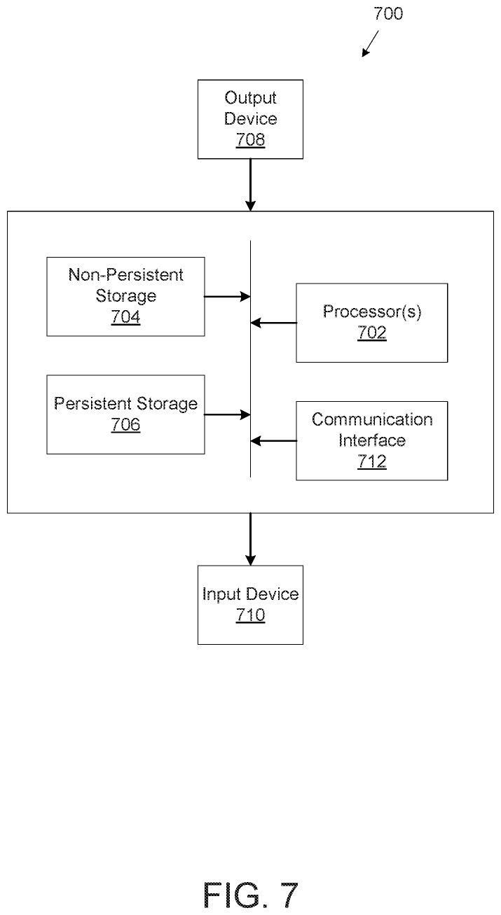

The clients (100) may be implemented using computing devices. The computing devices may be, for example, mobile phones, tablet computers, laptop computers, desktop computers, servers, or cloud resources. The computing devices may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions described in this application and/or all, or a portion, of the methods illustrated in FIGS. 5A-5C. The clients (100) may be implemented using other types of computing devices without departing from the invention. For additional details regarding computing devices, refer to FIG. 7.

The clients (100) may be implemented using logical devices without departing from the invention. For example, the clients (100) may include virtual machines that utilize computing resources of any number of physical computing devices to provide the functionality of the clients (100). The clients (100) may be implemented using other types of logical devices without departing from the invention.

The clients may store data. The clients may store the data using persistent storage (e.g., 102A, 102N). The persistent storage that the clients (100) use to store the data may be subject to degradation and/or failure. Degradation and/or failure of the persistent storage in which the data is stored may result in data loss.

In one or more embodiments of the invention, the clients (100) utilize persistent storage failure prediction services provided by the failure prediction system (110). Using the persistent storage failure prediction services may enable the clients (100) to avoid data loss due to degradation and/or failure of persistent storages used to store data.

To use the persistent storage failure prediction services, the clients (100) may perform actions under the directions of the failure prediction system (110). By doing so, the failure prediction system (110) may orchestrate the transmission of data and actions between the failure prediction system and the clients (100).

For example, a client (100) may send data regarding its persistent storage (102) to the failure prediction system (110). The failure prediction system (110) may generate prediction models that may generate predictions as to whether or not the persistent storage (102) of the client (100) (or other entity) is likely to fail.

If it is determined that a persistent storage is likely to fail, the failure prediction system (110) may initiate an action(s) for the client (100) to reduce the likelihood of data loss occurring. For example, the failure prediction system (200) may notify the client (100) that a persistent storage (e.g., 102A, 102N) is likely to fail. The clients (100) may utilize other and/or additional services provided by the failure prediction system (100) without departing from the invention.

A system in accordance with one or more embodiments of the invention may include any number of clients (e.g., 100A, 100N) without departing from the invention. For example, a system may include a single client (e.g., 100A) or multiple clients (e.g., 100A, 100N).

As noted above, the clients (100) may store data using persistent storages (e.g., 102A, 102N) utilize the persistent storage failure prediction services provided by the failure prediction system (100) to prevent data loss due to failure/degradation of the storages. The persistent storages (e.g., 102A, 102N) may be implemented using a physical storage device.

A physical storage device may be a physical device that provides data storage services. For example, a physical storage device may include any number of physical devices such as, for example, hard disk drives, solid state drives, tape drives, and/or other types of hardware devices that store data. The physical storage device may include any number of other types of hardware devices for providing data storage services. For example, the physical storage device may include storage controllers that balance and/or allocate storage resources of hardware devices, load balancers that distribute storage workloads across any number of hardware devices, memory for providing cache services for the hardware devices, etc.

In one or more embodiments of the invention, the persistent storages (e.g., 102A, 102N) provide data storage services to the clients (100) and/or other entities. The data storage services may include storing of data and providing of previous stored data. The persistent storages (e.g., 102A, 102N) may provide other and/or additional services to the clients (100) without departing from the invention.

In one or more embodiments of the invention, the failure prediction system (110) is implemented using a computing device. The computing device may be, for example, a mobile phone, tablet computer, laptop computer, desktop computer, server, distributed computing system, or a cloud resource. The computing device may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions described in this application and/or all, or a portion, of the methods illustrated in FIGS. 5A-5C. The failure prediction system (110) may be implemented using other types of computing devices without departing from the invention. For additional details regarding computing devices, refer to FIG. 7.

The failure prediction system (110) may be implemented using logical devices without departing from the invention. For example, the failure prediction system (110) may include virtual machines that utilize computing resources of any number of physical computing devices to provide the functionality of the failure prediction system (110). The failure prediction system (110) may be implemented using other types of logical devices without departing from the invention.

In one or more embodiments of the invention, the failure prediction system (110) provides persistent storage failure prediction services. Persistent storage failure prediction services may include (i) generation of prediction models including an initial model (144) and refined models (146), (ii) generation of persistent storage failure predictions for the persistent storages (102) of the clients (100), and/or (iii) initiating actions based on the predictions. By doing so, the failure prediction system (110) may reduce the likelihood of data loss from client persistent storage (102A, 102N) failure. The failure prediction system (110) may provide other and/or additional services without departing from the invention.

In one or more embodiments of the invention, the predictor (120) is implemented using a computing device. The computing device may be, for example, a mobile phone, tablet, laptop computer, desktop computer, server, distributed computing system, or a cloud resource. The computing device may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to provide the functionality of the predictor (120) described through this application and all, or a portion, of the methods illustrated in FIGS. 5A-5C. The predictor (120) may be implemented using other types of computing devices without departing from the invention. For additional details regarding computing devices, refer to FIG. 7.

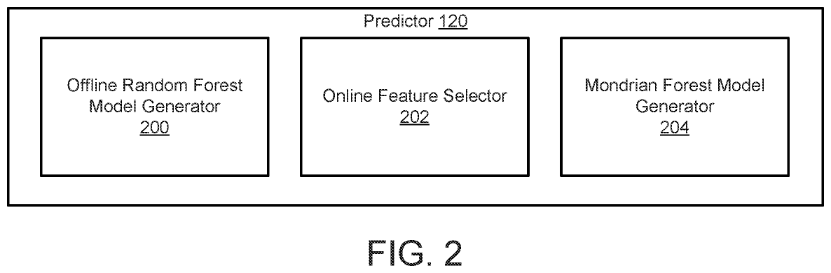

In one or more embodiments of the invention the predictor (120) provides prediction generation services. The prediction generation services may include (i) generating an initial model (144), (ii) generating refined models (146), and (iii) generating persistent storage failure predictions. The predictor (120) may provide other and/or additional services without departing from the invention. For additional details regarding the predictor (120), refer to FIG. 2.

In one or more embodiments of the invention, the training data manager (130) is implemented using a computing device. The computing device may be, for example, a mobile phone, tablet computer, laptop computer, desktop computer, server, distributed computing system, or a cloud resource. The computing device may include one or more processors, memory (e.g., random access memory), and persistent storage (e.g., disk drives, solid state drives, etc.). The persistent storage may store computer instructions, e.g., computer code, that (when executed by the processor(s) of the computing device) causes the computing device to provide the functionality of the training data manager (130) described through this application. The training data manager (130) may be implemented using other types of computing devices without departing from the invention. For additional details regarding computing devices, refer to FIG. 7.

In one or more embodiments of the invention, the training data manager (130) provides training data management services. Providing training data management services may include obtaining training data from the clients (100) and enabling the predictor (120) to access the obtained training data. The training data manager (130) may provide other and/or additional services without departing from the invention.

In one or more embodiments of the invention, the persistent storage (140) implemented using a storage device. The storage device may be implemented using physical storage devices and/or logical storage devices. The persistent storage (140) may be implemented using other types of devices that provide data storage services without departing from the invention.

A logical storage device may be an entity that utilizes the physical storage devices of one or more computing devices to provide data storage services. For example, a logical storage may be a virtualized storage that utilizes any quantity of storage resources (e.g., physical storage devices) of any number of computing devices.

A physical storage device may be a physical device that provides data storage services. For example, a physical storage device may include any number of physical devices such as, for example, hard disk drives, solid state drives, tape drives, and/or other types of hardware devices that store data. The physical storage device may include any number of other types of hardware devices for providing data storage services. For example, the physical storage device may include storage controllers that balance and/or allocate storage resources of hardware devices, load balancers that distribute storage workloads across any number of hardware devices, memory for providing cache services for the hardware devices, etc.

In one or more embodiments of the invention, the persistent storage (140) provides data storage services to the failure prediction system (110), the predictor (120), the training data manager (130), and/or other entities. The data storage services may include storing of data and providing of previous stored data. The persistent storage (140) may provide other and/or additional services without departing from the invention.

The persistent storage (140) may store data structures including a training data repository (142), the initial model (144), the refined models (146), a prediction repository (148), and a diagnostic repository (150). Each of these data structures are discussed below.

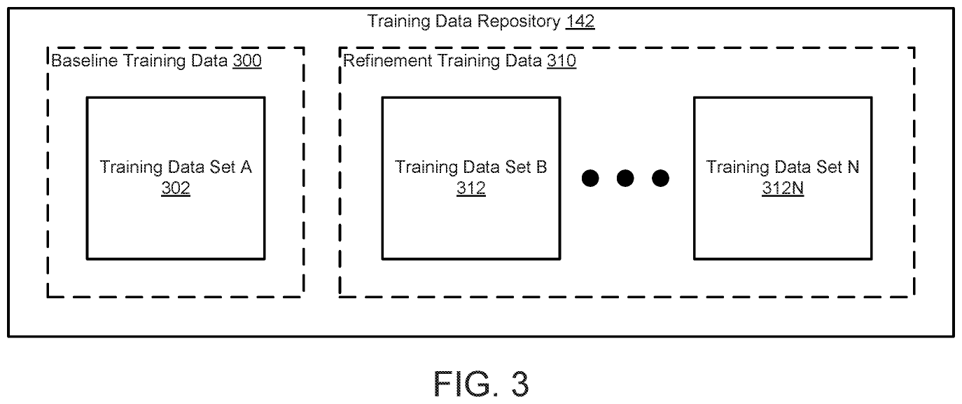

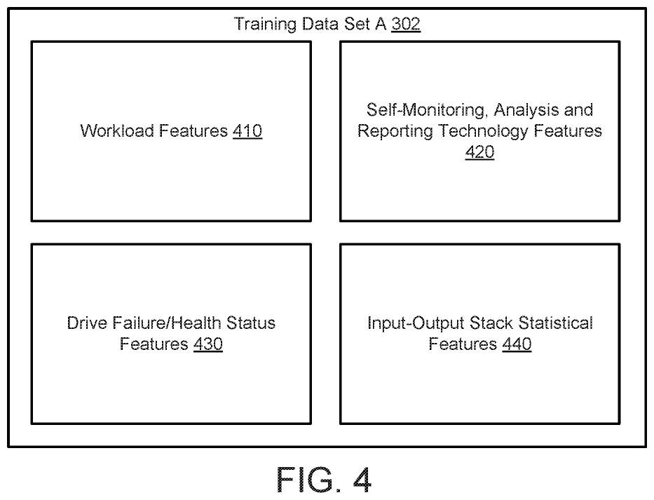

The training data repository (142) may be a data structure that may include data generated by the clients (100), maintained by the training data manager (130), and utilized by the predictor (120). The training data repository (142) may include any quantity of data. The data may include information regarding the persistent storages of the clients (100). The data may include several features. These features may be workload features (410, FIG. 4), self-monitoring, analysis and reporting technology features (420, FIG. 4), drive failure/health status features (430, FIG. 4), and input-output stack statistical features (440, FIG. 4). The data may include other and/or additional features without departing from the invention. For additional details regarding the training data repository (142), refer to FIG. 3.

The initial model (144) may be a data structure that may include a machine learning prediction model for persistent storage failure prediction that may be generated and utilized by the predictor (120). The initial model (144) may be, for example, an ensemble of individual decision trees created using baseline training data (300, FIG. 3) and a machine learning algorithm (e.g., the random forest machine learning algorithm). The initial model (144) may be generated prior to the refined models (146). While the persistent storage is illustrated as a single initial model, the persistent storage (140) may include any number of initial models without departing from the invention.

The refined models (146) may be data structures that represent any number of machine learning prediction models for persistent storage failure predictions that may be generated by the predictor (120) and utilized by the failure prediction system (110) to generate persistent storage failure predictions. The refined model (146) may be, for example, an ensemble of decision trees created using the initial model (144) (or a previously generated refined model (146)), refinement training data (310, FIG. 3), and a machine learning algorithm (e.g., the Mondrian forest machine learning algorithm). The refinement training data may include fewer features that are more relevant to persistent storage failure predictions that may have been selected by an online feature selector (202, FIG. 2). The machine learning algorithm may refine the initial model (144) by introducing the refinement training data (310, FIG. 3) into the initial model (144) (or a previously generated refined model (146)), and may perform one or more processes from a group of processes consisting of: creating a new split above a first existing split in the initial model (144), extending a second existing split in the initial model (144), and splitting an existing leaf of the initial model (144) into at least two child nodes in the refined model (146). The prediction repository (148) may be a data structure that stores predictions generated by the prediction models (e.g., 144, 146). The prediction repository (148) may store any number of generated predictions. The stored predictions may specify the likelihood that a persistent storage associated with a respective prediction will fail.

The diagnostic repository (150) may be a data structure that stores actions that the failure prediction system (110) may cause to be performed. The actions may be associated with different types of predictions that may be generated by the predictor (120). The actions may, for example, include doing nothing if a prediction indicates that a persistent storage is unlikely to fail, setting a flag to indicate that a persistent storage is likely to fail if a prediction indicates that the persistent storage is likely to fail, and/or sending a warning message to indicate that a persistent storage is likely to fail if a prediction indicates that the persistent storage is likely to fail. The diagnostic repository (150) may include additional, different, and/or fewer types of actions without departing from the invention.

While the data structures (e.g., 142, 144, 146, 148, 150) are illustrated as separate data structures and have been discussed as including a limited amount of specific information, any of the aforementioned data structures may be divided into any number of data structures, combined with any number of other data structures, and may include additional, less, and/or different information without departing from the invention. Additionally, while illustrated as being stored in the persistent storage (140), any of the aforementioned data structures may be stored in different locations (e.g., in persistent storage of other computing devices) and/or spanned across any number of computing devices (without departing from the invention.

As discussed above, the predictor (120) may generate persistent storage failure prediction models and persistent storage failure predictions. FIG. 2 shows a diagram of a predictor (120) in accordance with one or more embodiments of the invention. The predictor (120) may be similar to the one shown in FIG. 1. As discussed above, the predictor (120) may provide persistent storage failure prediction model generation services and persistent storage failure prediction generation services for the failure prediction system (110, FIG. 1).

To provide the aforementioned functionality of the predictor (120), the predictor may include an offline random forest model generator (200), an online feature selector (202), and a Mondrian forest model generator (204). Each component of the predictor (120) is discussed below.

The offline random forest model generator (200) may provide initial persistent storage failure prediction model generation services for the predictor (120).

To provide the initial persistent storage failure prediction model generation services, the offline random forest model generator (200) may obtain the baseline training data (300, FIG. 3) from the training data manager (130, FIG. 1), and use an initial machine learning algorithm with the baseline training data (300, FIG. 3) to generate an initial model (144, FIG. 1). The initial machine learning algorithm may be the offline random forest algorithm.

The offline random forest model generator (200) may use other machine learning algorithms, besides the random forest machine learning algorithm, to generate an initial model (144, FIG. 1) without departing from the invention.

The initial model may be a data structure that may include a machine learning prediction model for persistent storage failure prediction that may be generated by the offline random forest model generator (200). The initial model (144) may be, for example, an ensemble of individual decision trees created by a machine learning algorithm (e.g., the random forest machine learning algorithm) and using baseline training data (e.g., 300, FIG. 3) as input to the algorithm.

In one or more embodiments of the invention, the offline random forest model generator (200) is implemented using a physical device. The physical device may include circuitry. The physical device may be, for example, a field-programmable gate array, application specific integrated circuit, programmable processor, microcontroller, digital signal processor, or other hardware processor. The physical device may be adapted to provide the functionality of the offline random forest model generator (200) described throughout this application and/or all or a portion of the methods illustrated in FIGS. 5A-5C. The offline random forest model generator (200) may be some other physical device without departing from the invention.

The offline random forest model generator (200) may be implemented using computer instructions (e.g., computing code) stored on a persistent storage (e.g., 140, FIG. 1) that when executed by a processor of the predictor (120) causes the predictor to perform the functionality of the offline random forest model generator (200) described throughout this application and/or all or a portion of the methods illustrated in FIGS. 5A-5C.

In one or more embodiments of the invention, the online feature selector (202) provides feature selection services for the predictor (120) and/or other entities. The feature selection services may include selecting a subset of relevant features included in the baseline training data (300, FIG. 3) for use in the construction of the refined models (146, FIG. 1). The relevant features may be used to select the refinement training data (310, FIG. 3) from the clients (100, FIG. 1). For additional information regarding baseline training data (300) and refinement training data (310, FIG. 3), refer to FIG. 3. The online feature selector (202) may provide other and/or additional services without departing from the invention.

A feature may be an individual measurable property or characteristic of a phenomenon being observed. Features may be, for example, numeric representations of the observations of the phenomenon. For example, a feature pertaining to the persistent storage failure prediction may be persistent storage (e.g., 102, 102N, FIG. 1) temperature. The temperature of a persistent storage (e.g., 102, 102N, FIG. 1) may be a characteristic of persistent storage failure. For example, if the temperature of the persistent storage (e.g., 102, 102N, FIG. 1) exceeds a certain threshold, the persistent (e.g., 102, 102N, FIG. 1) storage may be more likely to fail than if the temperature did not exceed the aforementioned threshold.

Choosing certain features to include in machine learning model generation may lead to more effective models in persistent storage failure prediction. For example, two features that may be included in the baseline training data (300, FIG. 3) are persistent storage (e.g., 102A, FIG. 1) temperature and persistent storage (e.g., 102A, FIG. 1) read-write ratio. The online feature selector (202) may determine temperature is highly relevant to persistent storage failure prediction and that the read-write ratio is not very relevant to persistent storage (e.g., 102A, FIG. 1) failure prediction. In other words, the temperature may be strongly correlated with failure while the read-write ratio is not correlated with failure of persistent storage devices. Large differences in temperature may affect persistent storage (e.g., 102A, FIG. 1) failure, whereas large differences in read-write ratios may not affect persistent storage (e.g., 102A, FIG. 1) failure. In such a scenario, the online feature selector (202) may notify the failure prediction system (110, FIG. 1) of the relevancy of these two features, and the refinement training data (310, FIG. 3) used to generate the refined model may include the temperature feature and may not include the read-write ratio feature.

In one or more embodiments of the invention, the online feature selector (202) is implemented using a physical device. The physical device may include circuitry. The physical device may be, for example, a field-programmable gate array, application specific integrated circuit, programmable processor, microcontroller, digital signal processor, or other hardware processor. The physical device may be adapted to provide the functionality of the online feature selector (202) described throughout this application and/or all or a portion of the methods illustrated in FIGS. 5A-5C. The online feature selector (202) may be implemented using other types of physical devices without departing from the invention.

The online feature selector (202) may be implemented using computer instructions (e.g. computer code) stored on a persistent storage that when executed by a processor of the predictor (120) that cause the predictor (120) to provide the functionality of the online feature selector (202) described throughout this application and/or all or a portion of the methods illustrated in FIGS. 5A-5C.

In one or more embodiments of the invention, the Mondrian forest model generator (204) provides persistent storage failure prediction refined model generation services and persistent storage failure prediction generation services for the predictor (120). The persistent storage failure prediction refined model generation services may include (i) obtaining the refinement training data (310, FIG. 3), (ii) obtaining the previously generated prediction model from persistent storage (140, FIG. 1), (iii) introducing the refinement training data (310, FIG. 3) into the previously generated model, (iv) utilizing a Mondrian forest machine learning algorithm to refine the previously generated model (e.g., an initial model or a previously refined model), and (v) generating a refined model (146, FIG. 1). The Mondrian forest model generator (204) may provide other and/or additional services to the predictor (120) and/or other entities without departing from the invention.

The persistent storage failure prediction generation services may include obtaining live data from clients and using the refined model to generate a persistent storage failure prediction. The live data may include data obtained by a client (e.g., 110, FIG. 1) and sent to the failure prediction system (110, FIG. 1) at some point in time after the refinement training data (310, FIG. 3) was obtained, sent to the failure prediction system (110, FIG. 1), and/or utilized by the predictor (120, FIG. 1). The live data may include the relevant features included in the refinement training data (310, FIG. 3).

The live data may include a smaller amount of data than the initially obtained data of the baseline training data (300, FIG. 3) and the refinement training data. The live data may include data from only a single client (e.g., 100A), not all of the clients (100) that utilize the persistent storage failure prediction services.

The Mondrian forest model generator (204) may use other machine learning algorithms, besides the Mondrian forest machine learning algorithm, to generate refined models (e.g., 146, FIG. 1) without departing from the invention. The previously generated model mentioned above may be the initial model (144, FIG. 1) or a previously generated refined model (146, FIG. 1) without departing from the invention.

In one or more embodiments of the invention, the Mondrian forest model generator (204) is implemented using a physical device. The physical device may include circuitry. The physical device may be, for example, a field-programmable gate array, application specific integrated circuit, programmable processor, microcontroller, digital signal processor, or other hardware processor. The physical device may be adapted to provide the functionality of the Mondrian forest model generator (204) described throughout this application and/or all or a portion of the methods illustrated in FIGS. 5A-5C. The Mondrian forest model generator (204) may include other types of physical devices without departing from the invention.

The Mondrian forest model generator (204) may be implemented using computer instructions (e.g. computer code) stored on a persistent storage that when executed by a processor of the predictor (120) that cause the predictor (120) to provide the functionality of the Mondrian forest model generator (204) described throughout this application and/or all or a portion of the methods illustrated in FIGS. 5A-5C.

While the predictor (120) of FIG. 2 has been described and illustrated as including a limited number of components for the sake of brevity, a predictor (120) in accordance with embodiments of the invention may include additional, fewer, and/or different components than those illustrated in FIG. 2 without departing from the invention.

As discussed above, the training data repository (142) may include data structures stored in the persistent storage (140, FIG. 1) of the failure prediction system (110, FIG. 1). FIG. 3 shows a training data repository (142) in accordance with one or more embodiments of the invention. The training data repository (142) may be similar to the training data repository shown in FIG. 1. The data structures stored in the training data repository (142) may include training data provided by clients (100, FIG. 1) and utilized by a predictor (120, FIG. 1). The training data may include baseline training data (300) and/or refinement training data (310). Each of these data structures is discussed below.

The baseline training data (300) may be a data structure that includes data provided by the clients (100, FIG. 1). The data may include the data regarding the persistent storages (e.g., 102, FIG. 1) of the clients (100, FIG. 1). The baseline training data (300) may include any number of features. The baseline training data (300) may be used by the predictor (120, FIG. 1) to generate the initial model (144, FIG. 1). The baseline training data may include a training data set A (302). For additional information regarding training data set A, refer to FIG. 4. The baseline training data (300) may include other and/or additional training data sets without departing from the invention.

The refinement training data (310) may be a data structure including data provided by the clients (100). The refinement training data (310) may include data regarding the persistent storages (e.g., 102, FIG. 1) of the clients (100, FIG. 1). The refinement training data (310) may include fewer features than the baseline training data (300). The features included in the refinement training data (310) may be the features selected by the online feature selector (202, FIG. 2). The refinement training data (310) may be used by the predictor (120, FIG. 1) to generate refined models (146, FIG. 1). The refinement training data may include training data sets (e.g., 312). There may be any number of training data sets (e.g., 312 and 312N) in the refinement training data (310).

While the training data repository (142) of FIG. 3 has been described and illustrated as including a limited number of components for the sake of brevity, a training data repository (142) in accordance with embodiments of the invention may include additional, fewer, and/or different components than those illustrated in FIG. 3 without departing from the invention.

As discussed above, the baseline training data (310, FIG. 3) may include a training data set A (302). FIG. 4 shows the training data set A (302) in accordance with one or more embodiments of the invention. The training data set A (302) may be similar to the training data set A (302) shown in FIG. 3. Training data set A (302) may be a data structure that includes data from clients (100, FIG. 1) regarding the persistent storages of the clients (e.g. 102A, 102N, FIG. 1). The data in training data set A (302) may include any number of features. The features included in training data set A (302) may represent observable phenomena associated with persistent storage of the clients.

Training data set A (302) may include more features than the training data sets (e.g., 312, 312N, FIG. 3) included in the refinement training data (310). The features may include workload features (410), self-monitoring, analysis, and reporting technology features (420), drive failure/health status features (430), and input-output stack statistical features (440). The features may include other types of features without departing from the invention. Each of the feature types (410, 420, 430, and 440) is discussed below.

The workload features (410) may include features regarding the workload of the persistent storage of the clients (e.g., 102A, 102N, FIG. 1). These features, for example, may include random ratio, read-write ratio, and read-write block size of the persistent storages of the clients (e.g., 102A, 102N, FIG. 1). The random ratio may be the ratio of random to sequential operations performed by the persistent storage. The aforementioned operations may include read and write operations. Random operations may occur in a non-contiguous manner, meaning random operations access locations on the storage that may not be next to each other, (i.e., random). Sequential operations occur in a contiguous manner, meaning sequential operations may access locations on the storage that are next to each other (i.e., sequential). The read-write ratio may be the ratio of read operations of the persistent storage (e.g., 102A) to the write operations of the persistent storage (e.g., 102A). The read-write ratio may be calculated by dividing the number of read operations by the number of write operations of a persistent storage (e.g., 102A). The read-write block size may be the minimum size or amount of data of a persistent storage read or write operation will include. For example, the read-write block size may be 4 KB for a persistent storage (e.g., 102A), the amount of data written to the persistent storage (e.g., 102A) may take up a multiple of 4 KB. These features may include other and/or additional workload features (410) without departing from the invention.

The self-monitoring, analysis and reporting technology features (420) may include features regarding the self-monitoring, analysis and reporting technology of the persistent storages of the clients (e.g., 102A, 102N, FIG. 1). These features, for example, may include reallocated sectors, temperature, and flash endurance. Reallocated sectors may be particular sectors or blocks of a persistent storage (e.g., 102A) that include a read, write, and/or verification error. The persistent storage (e.g., 102A) may maintain a log of reallocated sectors, and may then transfer the data to a special reserve area on the persistent storage (e.g., 102A). The temperature of the persistent storage (e.g., 102A) may by calculated using a temperature sensor that takes temperature measurements of the persistent storage (e.g., 102A). The flash endurance is the amount of data that a persistent storage (e.g., 102A) is guaranteed to be able to write before wearing out and may be determined by the manufacturer of the persistent storage (e.g., 102A). These features may include other and/or additional self-monitoring, analysis and reporting technology features (420) without departing from the invention.

The drive failure/health status features may include failure and health status features regarding persistent storages of the clients (e.g., 102A 102N, FIG. 1). The drive failure/health status features (430) may include, for example, previous persistent storage (e.g., 102A, 102N, FIG. 1) failure predictions. These features may also include status information from persistent storages (e.g., 102A, FIG. 1) of a client (e.g., 100A) such as status flags that indicate correct operation of the persistent storage. For example, there may be a flag on the persistent storage that indicates if an operation was failed. The drive failure/health status features (430) may include other and/or additional drive failure/health status features (430) without departing from the invention.

The input-output stack statistical features (440) may include features regarding the input and output operations of the persistent storages of the clients (e.g., 102A 102N). The input-output stack statistical features (440) may include, for example, command timeouts, command retries, returned small computer system interface errors, and latency. The command timeout may be the amount of time allotted for a command to execute. If a command takes longer to execute than the command timeout, there may be a command timeout error. Command timeout may be determined by the manufacturer of the persistent storage (e.g., 102A). Command retries may be performances of commands previously attempted due to a command failure in past attempts. The persistent storages (e.g., 102A) may maintain a log of command retries. Returned small computer system interface errors may be failures of small computer system interface commands. These errors may occur when issues arise transferring data between computers and peripheral devices such as persistent storages (e.g., 102A). The persistent storages (102A) may maintain a log of returned small computer system interface errors. The input-output stack statistical features (440) may include other and/or additional features without departing from the invention.

While the training data set A (302) of FIG. 4 has been described and illustrated as including a limited number of components for the sake of brevity, a training data set A (302) in accordance with embodiments of the invention may include additional, fewer, and/or different components than those illustrated in FIG. 4 without departing from the invention.

As discussed above, a failure prediction system in accordance with embodiments of the invention may generate prediction models and provide persistent storage failure predictions. FIG. 5A-FIG. 5C show methods that may be performed by a failure prediction system when providing persistent storage failure prediction services.

FIG. 5A shows a flowchart of a method in accordance with one or more embodiments of the invention. The method depicted in FIG. 5A may be used to provide persistent storage failure prediction services in accordance with one or more embodiments of the invention. The method depicted in FIG. 5A may be performed by, for example, the failure prediction system (e.g., 110, FIG. 1). Other components of the system illustrated in FIG. 1 may perform all, or a portion, of the method of FIG. 5A without departing from the invention.

While FIG. 5A is illustrated as a series of steps, any of the steps may be omitted, performed in a different order, additional steps may be included, and/or any or all of the steps may be performed in a parallel and/or partially overlapping manner without departing from the invention.

In step 500, an initial prediction model is generated using an initial machine learning algorithm and baseline training data.

In one or more embodiments of the invention, the predictor obtains the baseline training data and introduces the baseline training data to an initial machine learning algorithm to generate the initial model. The initial machine learning algorithm may be, for example, the offline random forest algorithm. The offline random forest model algorithm, when operating on the baseline training data, may generate an ensemble of decision trees, each: (i) reflecting a subset of features included in the baseline training data and (i) generating a persistent storage failure prediction. The generated decision trees may be used, in accordance with the model, to generate persistent storage failure predictions. The initial model may be generated via other and/or additional methods without departing from the invention. For example, different types of machine learning algorithms may be utilized to generate corresponding data structures that may be used to generate persistent storage failure predictions without departing from the invention.

In step 502, a refined model is generated using the refinement training data, a second machine learning algorithm, and the preceding model.

In one or more embodiments of the invention, the predictor obtains the refinement training data and the preceding model and introduces the refinement training data into the preceding model. The predictor uses a second machine learning algorithm to refine the initial model and generate the refined model. The predictor may use the online Mondrian forest model generator to generate the refined model. Other machine learning algorithms may be used to refine the initial model to obtain the refined model without departing from the invention.

The refined model may be generated via the method illustrated in FIG. 5B. The refined model may be generated via other and/or additional methods without departing from the invention.

In one or more embodiments of the invention, the refined model is generated via the method illustrated in FIG. 5B. Other methods may be used to generate the refined model without departing from the invention.

In step 504, a prediction is generated using the refined model and live data from a client of clients.

In one or more embodiments of the invention, the predictor uses live data and the refined model to generate a persistent storage failure prediction for a client of clients. The predictor may obtain live data from the client.

The live data may include data regarding the persistent storage of the client. The live data may include a subset of features included in the baseline training data.

After obtaining the refined model and the live data, the predictor may introduce the live data into the refined model. In other words, the refined model may use the live data as input and produce a persistent storage failure prediction. The prediction may be that the persistent storage will fail or that the persistent storage will not fail. The prediction may be associated with a predetermined period of time (e.g., likely to fail within the next month) or may be general (e.g., that the persistent storage is likely to fail in the future). A prediction may be generated via other and/or additional methods without departing from the invention.

In step 506, it is determined whether the generated prediction implicates an action.

In one or more embodiments of the invention, the failure prediction system accesses the diagnostic repository and uses the generated prediction to determine if an action is implicated. As discussed above, the diagnostic repository may include persistent storage failure predictions and corresponding actions to be initiated by the failure prediction system. For example, the prediction may be that the persistent storage of a client will fail. Based on the prediction, the diagnostic repository may indicate that the failure prediction system is to trigger a flag on the client that indicates that the persistent storage is likely to fail. However, the prediction may be that the persistent storage of the client is unlikely to fail. Thus, it may be determined that the prediction does not implicate an action. Alternatively, a prediction of a persistent storage failure may not be associated with any actions by the diagnostic repository in a scenario in which it is unimportant to the operation of a device if its persistent storage fails. It may be determined that the generated prediction implicates an action via other and/or additional methods without departing from the invention.

If it is determined the prediction implicates an action, the method may proceed to step 508. If it is determined the prediction does not implicate an action, the method may end following step 506.

In step 508, performance of the action is initiated based on the prediction.

As discussed above, a prediction may be generated that implicates an action. The implicated action may be to trigger a flag that warns the client that the persistent storage will fail. The implicated action may be other types of actions without departing from the invention.

To initiate the performance of triggering a flag on the client, the failure prediction system may send a message requesting that the client trigger the flag. The client may trigger the flag in response to the request from the failure prediction system. By triggering the flag, other entities may be notified to take action. For example, other entities may perform actions that lessen the potential impact of a persistent storage failure, prevent a persistent storage failure, or otherwise proactive address the potential persistent storage failure. The performance of an action may be initiated via some other and/or additional methods without departing from the invention.

The method may end following step 508.

The method depicted in FIG. 5A may be logically divided into two portions, the initialization process (520) and the prediction process (530). The initialization process may include step 500 and the prediction process may include steps 502, 504, 506, and 508. The prediction process (530) portion of the method may be performed any number of times without departing from the invention. For example, an initial model may be generated, refined to obtain a refined model, and then further refined to obtain an additional refined model (i.e., further refining a refined model).

The predictor may generate any number of persistent storage prediction models using the initial model or the previously generated refined models without departing from the invention. The predictor may generate any number of persistent storage failure predictions without departing from the invention.

As discussed above, a refined model may be generated using the method illustrated in FIG. 5B. FIG. 5B shows a flowchart of a method in accordance with one or more embodiments of the invention. The method depicted in FIG. 5B may be used to generate a refined model that provides persistent storage failure predictions in accordance with one or more embodiments of the invention. The method shown in FIG. 5B may be performed by, for example, the predictor (e.g., 120, FIG. 1). Other components of the system illustrated in FIG. 1 may perform all, or a portion, of the method of FIG. 5B without departing from the invention.

While FIG. 5B is illustrated as a series of steps, any of the steps may be omitted, performed in a different order, additional steps may be included, and/or any or all of the steps may be performed in a parallel and/or partially overlapping manner without departing from the invention.

In step 510, the refinement training data is generated based on a subset of features of the baseline training data.

In one or more embodiments of the invention, the refinement training data is generated based on a subset of features included in the baseline training data. The refinement training data may include relevant features to persistent storage failure prediction (i.e., features that are correlated with failures). The predictor may use the online feature selector to identify the relevant features from the baseline training data. The online feature selector may use an online feature selection algorithm to identify the relevant features. The online feature selection algorithm may be, for example, the incremental wrapper-based feature subset selection algorithm. The online feature selection algorithm may be other feature selection algorithm without departing from the invention. After the relevant features are identified, the failure prediction system may notify the clients as to which features are relevant to persistent storage failure prediction.

For example, the failure prediction system may send a message that specifies the relevant features to the clients. In response to the relevant features message, the clients may send refinement training data to the failure prediction system that includes the relevant features. For example, the clients may monitor the relevant features over a period of time and provide the results (e.g., data representing the monitoring) of the monitoring over the period of time as the refinement training data.

The refinement training data may be stored in the training data repository of the persistent storage of the failure prediction system and may be used by the predictor. The refinement training data may be generated via other and/or additional methods without departing from the invention.

In step 512, the refined model is obtained by refining the initial model using the second machine learning algorithm and the refinement training data.

As discussed above, the predictor may obtain the refinement training data and the preceding model (e.g., an initial model or a previously generated refined model) and introduce the refinement training data into the preceding model. The predictor may use a second machine learning algorithm to refine the initial model or the preceding model and create the refined model. The second machine learning algorithm may be the online Mondrian forest algorithm. The predictor may use the online Mondrian forest model generator to generate the refined model. The Mondrian forest model generator may use the Mondrian forest algorithm to refine the preceding model to include the refinement training data to generate the refined model.

The refined model may be generated via the method illustrated in FIG. 5C. The refined model may be generated via other and/or additional methods without departing from the invention.

The method may end following step 512.

As discussed above, a refined model may be generated using the method illustrated in FIG. 5C. FIG. 5C shows a flowchart of a method in accordance with one or more embodiments of the invention. The method depicted in FIG. 5C may be used to generate a refined model that provides persistent storage failure predictions in accordance with one or more embodiments of the invention. The method shown in FIG. 5C may be performed by, for example, the predictor (e.g., 120, FIG. 1). Other components of the system illustrated in FIG. 1 may perform all, or a portion, of the method of FIG. 5C without departing from the invention.

While FIG. 5C is illustrated as a series of steps, any of the steps may be omitted, performed in a different order, additional steps may be included, and/or any or all of the steps may be performed in a parallel and/or partially overlapping manner without departing from the invention.

In step 514, the refinement training data is introduced into the initial model.

As discussed above, the predictor may obtain the refinement training data and the initial model. The predictor may then introduce the refinement training data into the initial model. Introducing the refinement training data may include, for example, incrementally adding data points from the refinement training data into decision trees of the initial or refined model. The refinement training data may be introduced to a preceding refined model instead of the initial model without departing from the invention. The refinement training data may be introduced into the initial model via other and/or additional methods without departing from the invention.

In step 516, the refined model is generated by performing one process from a group of processes consisting of creating a new split above a first existing split in the initial model, extending a second existing split in the initial model, and splitting an existing leaf of the initial model into at least two child nodes in the refined model.

As discussed above, refinement training data may be introduced into the initial model. A second machine learning algorithm may determine how to refine the initial model so the decision tree of the initial model includes the added refinement training data point. As discussed above, the second machine learning algorithm may be the Mondrian forest algorithm. The Mondrian forest algorithm may refine the initial model by performing one process from a group of processes consisting of creating a new split above a first existing split in the initial model, extending a second existing split in the initial model, and splitting an existing leaf of the initial model into at least two child nodes in the refined model.

For example, a refinement training data point may be added to a decision tree in the initial model. The second machine learning algorithm may perform one of the aforementioned processes to refine the initial model to include the added refinement training data point in the decision tree. For example, the second machine learning algorithm may determine to create a new split including the refinement training data point above a first existing split in the initial model. The second machine learning algorithm may repeat this method for newly introduced refinement training data points. The refined model may be generated via other and/or additional methods without departing from the invention.

The method may end following step 516.

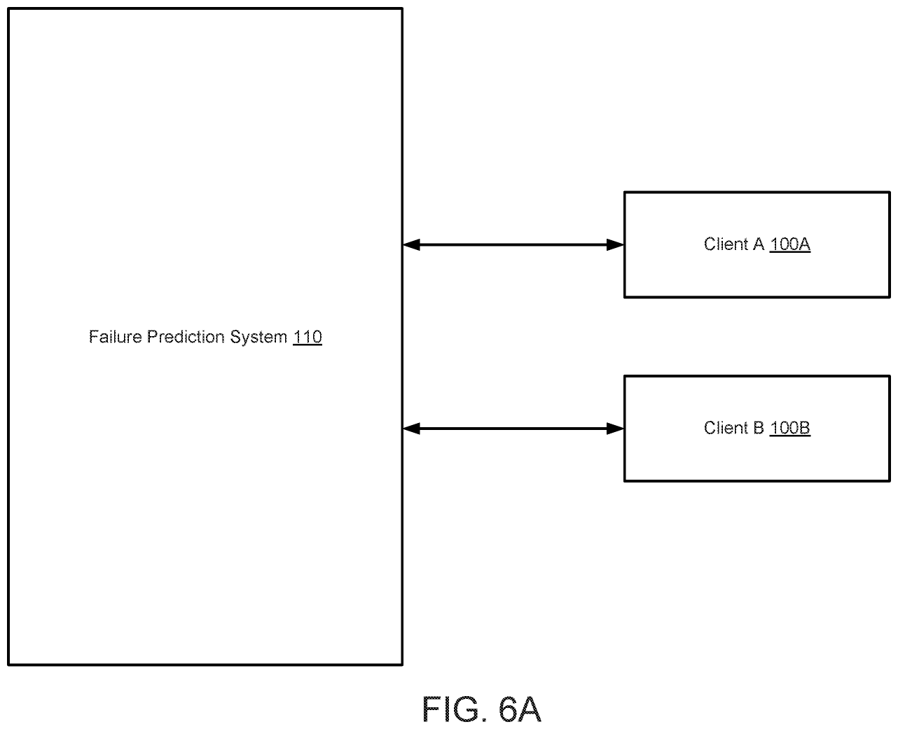

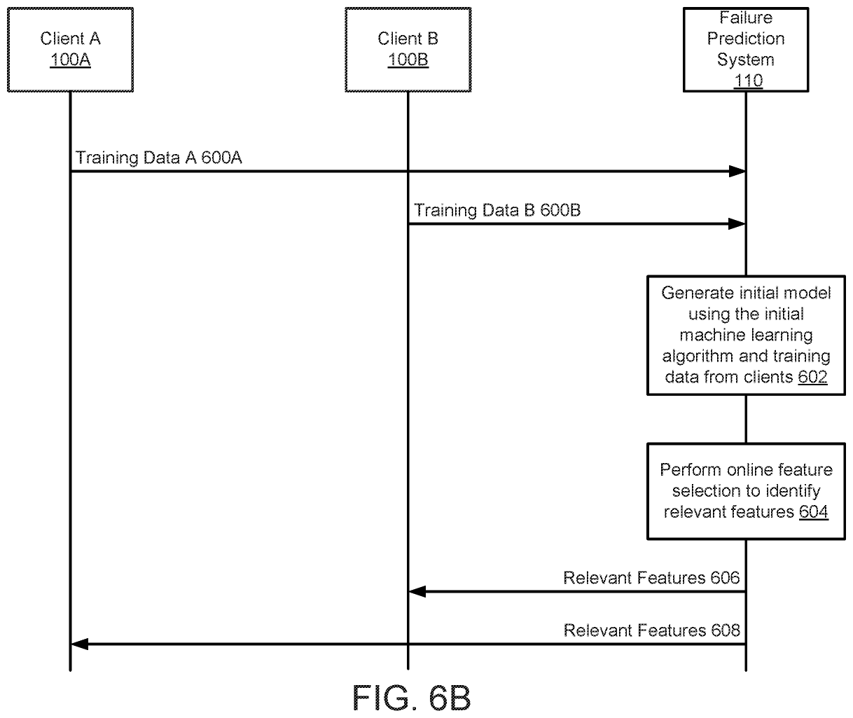

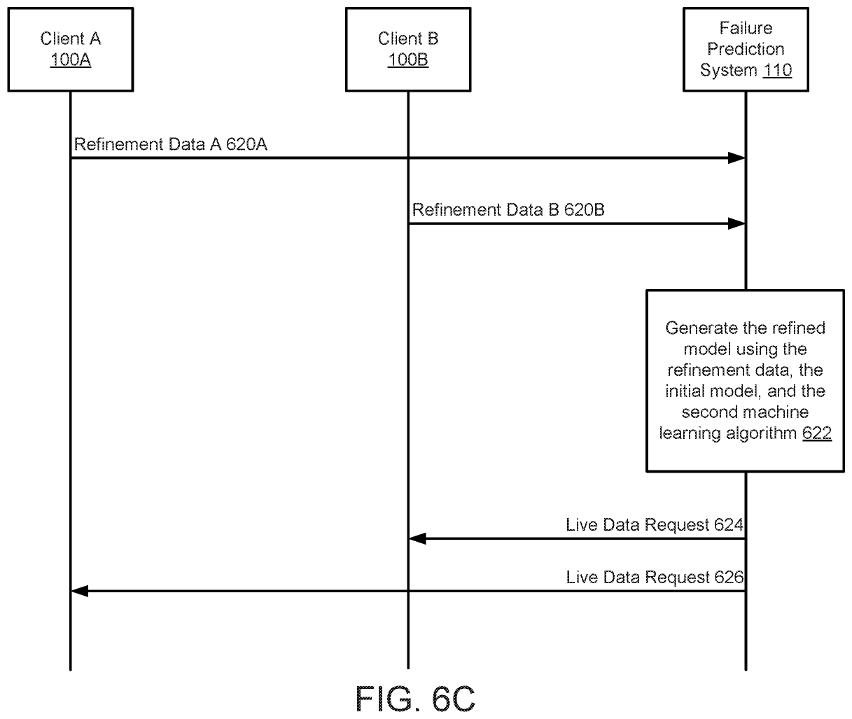

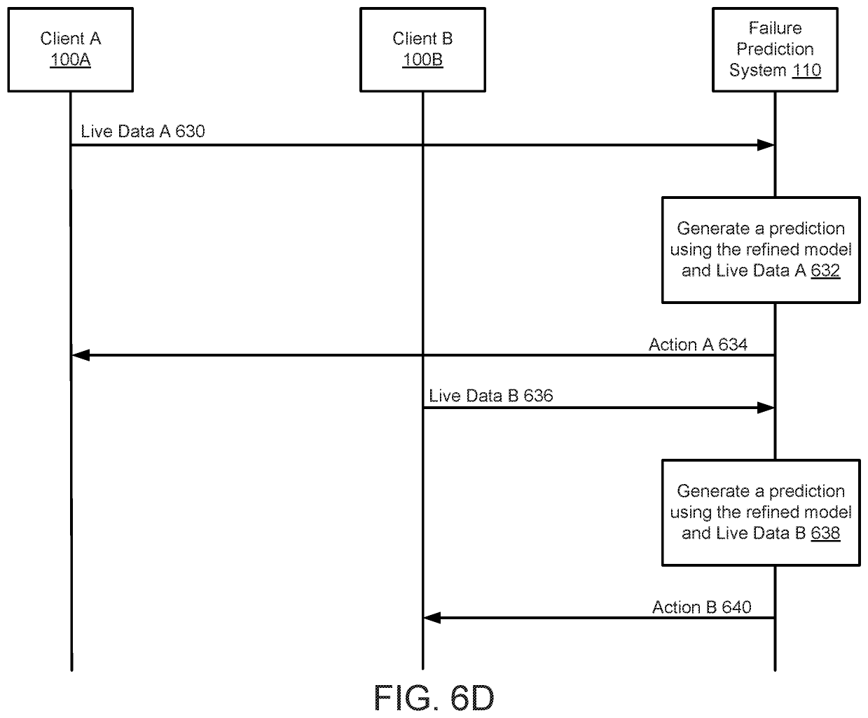

To further clarify aspects of embodiments of the invention, a nonlimiting example is provided in FIGS. 6A-6D. FIG. 6A shows a diagram of an example system and FIGS. 6B-6D shows diagrams of actions that may be performed by the example system of FIG. 6A. The system of FIG. 6A may be similar to that of FIG. 1. For the sake of brevity, only a limited number of components of the system of FIG. 1 are illustrated in FIG. 6A.

### Example

Consider a scenario as illustrated in FIG. 6A in which a failure prediction system (110) is providing persistent storage failure prediction services for two clients, client A (100A) and client B (100B). As discussed above, other components of the failure prediction system (110) are not illustrated in FIGS. 6A-6D for brevity.

To provide such persistent storage failure prediction services, the clients (100A and 100B) (or other entities such as a manager of the clients) may request a persistent storage failure prediction from the failure prediction system (110). FIG. 6B shows an interaction diagram that illustrates interactions between the failure prediction system (110), client A (100A), and client B (100B).

At a first point in time, client A (100A) sends training data A (600A) to the failure prediction system (110). Then client B (100B) sends training data B (600B) to the failure prediction system (110). Client B (600B) may send training data B (600B) to the failure prediction system (110) prior to client A (100A) sending training data A (600A) to the failure prediction system (110) without departing from the invention. After obtaining training data A (600A) and training data B (600B), the failure prediction system (110) generates an initial model using an initial machine learning algorithm and the training data (600A, 600B) from the clients (602).

Once the initial model is generated, the failure prediction system (110) performs online feature selection to identify relevant features (604). The failure prediction system (110) then sends a message including the relevant features (606) to client B (100B), notifying client B (100B) as to which features are relevant to persistent storage failure prediction. Then the failure prediction system (110) also sends a message including the relevant features (608) to client A (100A) notifying client A (100A) as to which features are relevant to persistent storage failure prediction. The failure prediction system (110) may send the message including the relevant features (608) to client A (100A) prior to the failure prediction system (110) sending the message including the relevant features (606) to client B (100B) without departing from the invention.

After generating the initial model and identifying the relevant features for persistent storage failure predictions, the failure prediction system (110) may generate a refined model. FIG. 6C shows a second interaction diagram illustrating interactions between the failure prediction system (110), client A (100A), and client B (100B).

Once notified of the relevant features, client A (100A) sends refinement data A (620A) to the failure prediction system (110). Client B (100B) sends refinement data B (620B) to the failure prediction system (110). Client B (100B) may send refinement data B (620B) to the failure prediction system (110) prior to client A (100A) sending refinement data A (620A) to the failure prediction system (110) without departing from the invention.

After obtaining refinement data A (620A) and refinement data B (620B) from client A (100A) and client B (100B) respectively, the failure prediction system (110) generates the refined model using the refinement data, the initial model, and the second machine learning algorithm (622). Once the refined model is generated (622), the failure prediction system (110) sends a live data request (624) to client B (100B). Then the failure prediction system (110) sends a live data request (626) to client A (100A). The failure prediction system (110) may send a live data request (626) to client A (100A) prior to sending a live data request (624) to client B (100B) without departing from the invention.

After generating a refined model, the failure prediction system (110) may generate persistent storage failure predictions for the clients (100A, 100B). FIG. 6D shows an interaction diagram between a failure prediction system (110), client A (100A), and client B (100B).

After obtaining the request for live data (626) from the failure prediction system (110), client A (100A) sends live data A (630) to the failure prediction system (110). Once the failure prediction system (110) receives the live data A (632) from client A (100A), the failure prediction system (110) generates a prediction using the refined model and live data A (632). After generating the prediction (632), the failure prediction system (110) sends a message to client A (100A) to initiate action A (634).

Once the failure prediction system (110) sends the message initiating action A (634) for client A (100A), Client B (100B) sends live data B (636) to the failure prediction system (110). After the failure prediction system (110) obtains live data B (636), the failure prediction system (110) generates a prediction using the refined model and live data B (638). Once the prediction is generated, the failure prediction system (110) sends a message to client B (100B) to initiate action B (640).

The failure prediction system (110) may obtain live data B (636), generate a prediction (638), and initiate action B (640) prior to the failure prediction system (110) obtaining live data A (630), generating a prediction (632), and initiating action A (634) without departing from the invention.

End of Example

Thus, as illustrated in FIGS. 6A-6D, embodiments of the invention may provide a method for predicting future failures of storage devices. By predicting such future failures, future failures may be proactively addressed. Consequently, the impact of the potential future failures may be reduced.

As discussed above, embodiments of the invention may be implemented using computing devices. FIG. 7 shows a diagram of a computing device in accordance with one or more embodiments of the invention. The computing device (700) may include one or more computer processors (702), non-persistent storage (704) (e.g., volatile memory, such as random access memory (RAM), cache memory), persistent storage (706) (e.g., a hard disk, an optical drive such as a compact disk (CD) drive or digital versatile disk (DVD) drive, a flash memory, etc.), a communication interface (712) (e.g., Bluetooth interface, infrared interface, network interface, optical interface, etc.), input devices (710), output devices (708), and numerous other elements (not shown) and functionalities. Each of these components is described below.

In one embodiment of the invention, the computer processor(s) (702) may be an integrated circuit for processing instructions. For example, the computer processor(s) may be one or more cores or micro-cores of a processor. The computing device (700) may also include one or more input devices (710), such as a touchscreen, keyboard, mouse, microphone, touchpad, electronic pen, or any other type of input device. Further, the communication interface (712) may include an integrated circuit for connecting the computing device (700) to a network (not shown) (e.g., a local area network (LAN), a wide area network (WAN) such as the Internet, mobile network, or any other type of network) and/or to another device, such as another computing device.

In one embodiment of the invention, the computing device (700) may include one or more output devices (708), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (702), non-persistent storage (704), and persistent storage (706). Many different types of computing devices exist, and the aforementioned input and output device(s) may take other forms.

Embodiments of the invention may provide a computationally efficient method of predicting future storage failures. By making such predictions, the potential future storage failures may be proactively remediated to reduce the impact of such failures.

To make predictions of future storage failures, embodiments of the invention may utilize a multiphase learning process. In a first phase, the method may utilize large amounts of data from numerous sources to generate a first prediction framework (e.g., a first trained machine learning model). After generating the first prediction framework, the method may interrogate the first prediction framework to ascertain which of the sources of data are most relevant to generating accurate predictions. Once determined, a second prediction framework (e.g., a second trained machine learning model) may be generated that utilizes smaller amounts of data for generating predictions while still providing accurate predictions. For example, generating predictions using the second prediction framework may use less storage space, less memory space, use fewer processor cycles to generate predictions, etc. By doing so, embodiments of the invention may provide methods and systems for generating predictions at a lower computational cost than contemporary methods.

Thus, embodiments of the invention may address the problem of limited computational resource availability by decreasing the computational cost for generating predictions.

The problems discussed above should be understood as being examples of problems solved by embodiments of the invention disclosed herein and the invention should not be limited to solving the same/similar problems. The disclosed invention is broadly applicable to address a range of problems beyond those discussed herein.

One or more embodiments of the invention may be implemented using instructions executed by one or more processors of the data management device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A failure prediction system for predicting when persistent storage failures of clients will occur, comprising:
persistent storage for storing:
baseline training data, and
refinement training data; and
a predictor programmed to:
generate an initial prediction model using an initial machine learning algorithm and the baseline training data;
generate a refined model using:
the refinement training data,
a second machine learning algorithm, and
the initial model;
generate a prediction using:
the refined model, and
live data from a client of the clients;
make a determination that the prediction implicates an action;
initiate performance of the action based on the determination.

2. The failure prediction system of claim 1, wherein generating the refined model comprises:
generating the refinement training data based on a subset of features of the baseline training data; and
refining the initial model, to obtain the refined model, using:
the second machine learning algorithm, and
the refinement training data.

3. The failure prediction system of claim 2, wherein refining the initial model comprises:
introducing the refinement training data into the initial model; and
generating the refined model by performing one process from a group of processes consisting of:
creating a new split above a first existing split in the initial model,
extending a second existing split in the initial model, and
splitting an existing leaf of the initial model into at least two child nodes in the refined model.

4. The failure prediction system of claim 1, wherein the refinement training data comprises training data obtained from at least two of the clients.

5. The failure prediction system of claim 4, wherein the live data comprises second training data obtained from only the client of the clients.

6. The failure prediction system of claim 4, wherein the training data comprises at least one feature selected from a group of features consisting of:
workload features;
self-monitoring, analysis and reporting technology features;
disk health status features; and
input-output stack statistical features.

7. The failure prediction system of claim 4, wherein the baseline training data comprises more features than the refinement data.

8. A method for operating a persistent storage failure prediction system, comprising:
generating an initial prediction model using an initial machine learning algorithm and baseline training data;
generating a refined model using:
refinement training data,
a second machine learning algorithm, and
the initial model;
generating a prediction using:
the refined model, and
live data from a client of the clients;
making a determination that the prediction implicates an action;
initiating performance of the action based on the determination.

9. The method of claim 8, wherein generating the refined model comprises:
generating the refinement training data based on a subset of features of the baseline training data; and
refining the initial model, to obtain the refined model, using:
the second machine learning algorithm, and
the refinement training data.

10. The method of claim 9, wherein refining the initial model comprises:
introducing the refinement training data into the initial model; and
generating the refined model by performing one process from a group of processes consisting of:
creating a new split above a first existing split in the initial model,
extending a second existing split in the initial model, and
splitting an existing leaf of the initial model into at least two child nodes in the refined model.

11. The method of claim 8, wherein the refinement training data comprises training data obtained from at least two clients.

12. The method of claim 11, wherein the live data comprises second training data obtained from only one client of the clients.

13. The method of claim 11, wherein the training data comprises at least one feature selected from a group of features consisting of:
workload features;
self-monitoring, analysis and reporting technology features;
disk health status features; and
input-output stack statistical features.

14. The method of claim 11, wherein the baseline training data comprises more features than the refinement data.

15. A non-transitory computer readable medium comprising computer readable program code, which when executed by a computer processor enables the computer processor to perform a method for operating a persistent storage failure prediction system, the method comprising:
generating an initial prediction model using an initial machine learning algorithm and baseline training data;
generating a refined model using:
refinement training data,
a second machine learning algorithm, and
the initial model;
generating a prediction using:
the refined model, and
live data from a client of the clients;
making a determination that the prediction implicates an action;
initiating performance of the action based on the determination.

16. The non-transitory computer readable medium of claim 15, wherein generating the refined model comprises:
generating the refinement training data based on a subset of features of the baseline training data; and
refining the initial model, to obtain the refined model, using:
the second machine learning algorithm, and
the refinement training data.

17. The non-transitory computer readable medium of claim 16, wherein refining the initial model comprises:
introducing the refinement training data into the initial model; and
generating the refined model by performing one process from a group of processes consisting of:
creating a new split above a first existing split in the initial model,
extending a second existing split in the initial model, and
splitting an existing leaf of the initial model into at least two child nodes in the refined model.

18. The non-transitory computer readable medium of claim 15, wherein the refinement training data comprises training data obtained from at least two clients.

19. The non-transitory computer readable medium of claim 18, wherein the live data comprises second training data obtained from only one client of the clients.

20. The non-transitory computer readable medium of claim 18, wherein the training data comprises at least one feature selected from a group of features consisting of:
workload features;
self-monitoring, analysis and reporting technology features;
disk health status features; and
input-output stack statistical features.
